(19) United States
(12) Patent Application Publication
(10) Pub. No.: US 2016/0288040 A1
(43) Pub. Date: Oct. 6, 2016

(54) AIR PURIFICATION SYSTEM AND METHOD WITH BIOLOGICAL TREATMENT OF A SCRUBBER LIQUID

(71) Applicant: Bio Clean Air Innovation Ltd

(72) Inventor: AMIR ASA, Nahariya (IL)

(21) Appl. No.: 14/676,860

(22) Filed: Apr. 2, 2015

(51) Int. Cl. B01D 53/00; B01D 53/14; C02F 3/00; B01D 53/18

(52) U.S. Cl. CPC B01D 53/007; B01D 53/18; B01D 53/1425; C02F 3/00; C02F 2103/18

(57) ABSTRACT

An air purification system for purifying polluted air includes a scrubber in which a pollutant in the polluted air is transferred to a scrubber liquid. A biological treatment unit includes at least one substantially flat substrate to support a microorganism population to remove the transferred pollutant from the scrubber liquid when the scrubber liquid with the transferred pollutant is distributed on the substrate. A plane of the substrate is substantially parallel to a direction of flow of the air from the scrubber.

### FIELD OF THE INVENTION

The present invention relates to an air purification system. More particularly, the present invention relates to an air purification system and method with biological treatment of a scrubber liquid.

### BACKGROUND OF THE INVENTION

In the modern industrial age, the amount of pollutants that are emitted to the atmosphere by various sources increases year by year. These pollutants may directly adversely affect the health of both people and animals. In addition, polluting emissions may cause indirect and direct damage to the environment and contribute to global warming

### SUMMARY OF THE INVENTION

There is thus provided, in accordance with an embodiment of the present invention, an air purification system for purifying polluted air, the system including: a scrubber in which a pollutant in the polluted air is transferred to a scrubber liquid; and a biological treatment unit including at least one substantially flat substrate to support a microorganism population to remove the transferred pollutant from the scrubber liquid when the scrubber liquid with the transferred pollutant is distributed on the at least one substrate, a plane of the at least one substrate being substantially parallel to a direction of flow of the air from the scrubber.

Furthermore, in accordance with an embodiment of the present invention, the system further includes a photo-catalytic processor in which the polluted air is exposed to a catalyst to facilitate conversion of a pollutant component of the polluted air that is insoluble in the scrubber liquid to a substance that is soluble in the scrubber liquid.

Furthermore, in accordance with an embodiment of the present invention, the catalyst is formed by irradiating a material with ultraviolet radiation.

Furthermore, in accordance with an embodiment of the present invention, the material includes a mixture of hydrogen peroxide and water.

Furthermore, in accordance with an embodiment of the present invention, the system includes a blower to cause the air to flow.

Furthermore, in accordance with an embodiment of the present invention, the system includes a pump to cause the scrubber fluid to flow.

Furthermore, in accordance with an embodiment of the present invention, the system includes a demister to remove droplets from the air.

Furthermore, in accordance with an embodiment of the present invention, the system includes one or a plurality of nozzles to distribute the scrubber liquid onto the substrate.

Furthermore, in accordance with an embodiment of the present invention, the system includes a physicochemical processor to facilitate precipitation of a precipitable pollutant out of the scrubber liquid.

Furthermore, in accordance with an embodiment of the present invention, the physicochemical processor is configured to mix the scrubber liquid with a chemical substance to facilitate the precipitation.

Furthermore, in accordance with an embodiment of the present invention, the system is configured to recycle the scrubber liquid for use in the scrubber after treatment of the scrubber liquid in the biological treatment unit.

There is further provided, in accordance with an embodiment of the present invention, an air purification method for purifying polluted air, the method including: exposing a scrubber liquid to the polluted air in a scrubber to enable a pollutant in the polluted air to transfer to the scrubber liquid; distributing the scrubber liquid with the transferred pollutant on a substantially flat substrate of a biological treatment unit to enable a microorganism population that is supported by the substrate to remove the pollutant from the scrubber liquid; and causing air from the scrubber to flow across a surface of the substrate in a direction that is substantially parallel to the surface.

Furthermore, in accordance with an embodiment of the present invention, the method further includes exposing the polluted air to a catalyst that is produced by irradiating a material with ultraviolet radiation.

Furthermore, in accordance with an embodiment of the present invention, the material includes a mixture of hydrogen peroxide and water.

Furthermore, in accordance with an embodiment of the present invention, the method further includes demisting the air.

Furthermore, in accordance with an embodiment of the present invention, the method further includes processing the scrubber liquid with a physicochemical process to facilitate precipitation of a precipitable pollutant out of the scrubber liquid.

Furthermore, in accordance with an embodiment of the present invention, the physicochemical process includes mixing the scrubber liquid with a chemical substance.

Furthermore, in accordance with an embodiment of the present invention, the precipitable pollutant includes a metal.

Furthermore, in accordance with an embodiment of the present invention, the method further includes recycling the scrubber liquid to the scrubber after removal of the pollutant by the microorganism population.

There is further provided, in accordance with an embodiment of the present invention, a biological treatment unit for an air purification system, the unit including at least one substantially flat substrate to support a microorganism population onto which a scrubber liquid may be distributed after a pollutant is transferred from polluted air to the scrubber liquid in a scrubber, the microorganism population to remove the pollutant from a scrubber liquid, a plane of the substrate being substantially parallel to a direction of flow of the air from the scrubber.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 is a schematic illustration of an air purification system, in accordance with an embodiment of the present invention.

FIG. 2 is a block diagram illustrating a method of air purification, in accordance with an embodiment of the present invention.

FIG. 3 is a flowchart depicting a method of air purification, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, us of the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the present invention, an air purification system includes a scrubber. Air (to be understood as including any gaseous emission product) that contains pollutants may be emitted by an industrial or other process. The pollutants may include various types of pollutant molecules, atoms, ions, droplets, or particles. The polluted air is directed into the scrubber. Prior to entering the scrubber, the polluted air may be subjected to a catalytic process to convert at least some pollutants that are insoluble in a scrubber liquid (e.g., water) to soluble compounds.

Within the scrubber, the polluted air is exposed to the scrubber liquid. For example, the polluted air may pass through a flow (e.g., spray or stream) of the scrubber liquid (e.g., that includes water). Exposure of the polluted air to the scrubber liquid may cause pollutant molecules in the polluted air to be captured by (e.g., dissolved, absorbed, or adhere), or otherwise be transferred to, the scrubber liquid. The exposed scrubber liquid, which contains the captured pollutants, is collected in a collection container. The air that has been exposed to the scrubber liquid is herein referred to as purified air.

The exposed scrubber liquid may be treated to enable its reuse. The treatment is configured to remove some or all of the captured pollutants from the exposed scrubber liquid. The treatment may involve various physical, chemical, or biological processes for removal of captured pollutants.

For example, metallic components or other precipitable components that are captured in the exposed scrubber liquid may be subjected to a metal removal process to facilitate precipitation of the precipitable components out of the exposed scrubber liquid. The process may promote coagulation, flocculation, or other precipitation of captured metallic materials or other precipitable materials out of the exposed scrubber liquid. The precipitated metallic components or other precipitable components may form a sludge that may be removed from the system.

Components of the captured pollutants in the exposed scrubber liquid may be removed by a biological purification process. In the biological process, the exposed scrubber liquid is brought into contact with a substantially flat mucous substrate. For example, the exposed scrubber liquid may be sprayed, misted, or otherwise caused to form a layer that is in contact with an exposed surface of the mucous substrate. The mucous substrate is configured to host biological material that includes a population variety of microorganisms. As part of the biological purification process, captured pollutants in the exposed scrubber liquid may be utilized as nutrients for various metabolic processes of the microorganisms on the substrate. The pollutants may thus be incorporated into the mass of biological material on the substrate. The pollutants may be thus removed from the scrubber liquid.

The utilization of the dissolved pollutants by at least part of the microorganism population may utilize oxygen and produce carbon dioxide and water. The plane of the mucous substrate is arranged substantially parallel to the direction of flow of the purified air out of the scrubber after exposure of the polluted air to the scrubber liquid. Thus, layer of exposed scrubber liquid on the mucous substrate is exposed on one side to the biological material on the mucous substrate, and to the flow of purified air on the other side. Exposure of the layer of exposed scrubber liquid to the flow of the purified air may expedite exchange of gasses between the purified air and the layer of exposed scrubber liquid. For example, the exchange of gasses may include providing oxygen from the purified air to the scrubber liquid and the biological material. The exchange of gasses may include removal by the purified air of carbon dioxide that is produced by the biological process.

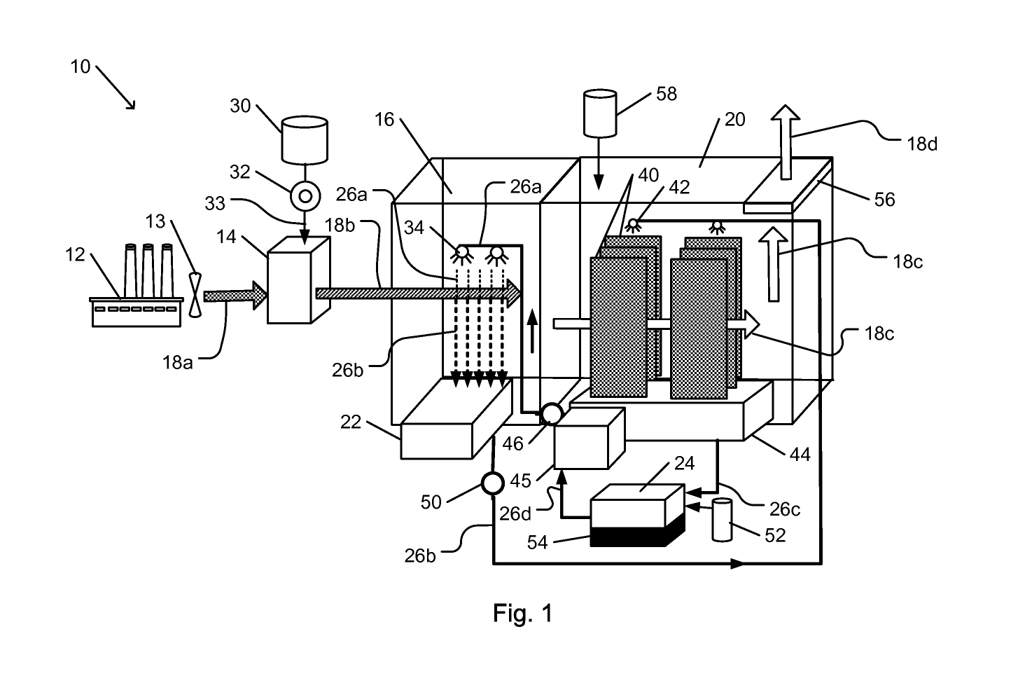

FIG. 1 is a schematic illustration of an air purification system, in accordance with an embodiment of the present invention.

It should be noted that the placement and orientations of various arrows in FIG. 1 (e.g., arrows labeled 18a-18d, 26a-26d, 33, and other labeled or unlabeled arrows) has been selected for convenience and clarity only. In particular, unless otherwise stated, no significance should be understood as implied by the horizontal or vertical orientation or any such arrow.

Air purification system 10 is configured to purify polluted air 18a that is emitted by a polluting process 12. For example, polluting process 12 may include combustion, or another industrial or other process that produces polluting gasses, vapor, particles, or other polluting products as a byproduct of the process. The polluting products may become mixed with air, or one or more atmospheric components, as part of polluting process 12.

Polluted air 18a may be forced through air purification system 10 by blower 13. Blower 13 may represent one or more component blowers, fans, or other active or passive mechanisms, devices, or units that facilitate movement of air or gasses through air purification system 10. The various component devices of blower 13 may be located at a single location, e.g., at an intake opening or point, at an output vent or point, or at another point of air purification system 10. Alternatively or in addition, various component devices of blower 13 may be distributed at various points within air purification system 10.

Polluted air 18a may be directed to flow through photo-catalytic processing unit 14. Photo-catalytic processing unit 14 may include a chamber, reactor, or vessel within which polluted air 18a mixes with or is otherwise exposed to catalyst 33. For example, catalyst 33 may be formed by irradiating a material, such as a catalyst formation mixture, from catalyst supply 30 with ultraviolet (UV) radiation from UV radiation source 32. For example, UV radiation source 32 may include a gas-emission or other type of lamp or source of UV radiation. The catalyst formation mixture may include a mixture of water and hydrogen peroxide, or another suitable material or mixture. The irradiation of the catalyst formation mixture with UV radiation may form a catalyst 33 that includes compounds with free radicals.

Catalyst 33 may be introduced into photo-catalytic processing unit 14 to mix with polluted air 18a. For example, catalyst 33 may be introduced into photo-catalytic processing unit 14 in the form of a liquid spray or mist, or otherwise.

Polluted air 18a may initially include one or more components that are insoluble in a scrubber liquid 26a, such as, for example, water (or other aqueous or polar solvent). Such components may include, for example, organic compounds such as hexane. Exposure of polluted air 18a to catalyst 33 in photo-catalytic processing unit 14 may convert one or more insoluble components of polluted air 18a to a material or substance that is soluble in scrubber liquid 26a. Thus, the composition of catalyzed polluted air 18b that exits from photo-catalytic processing unit 14 may be more soluble than the composition of polluted air 18a.

In some cases, air purification system 10 may not include photo-catalytic processing unit 14, or polluted air 18a may not be directed to flow through photo-catalytic processing unit 14. For example, the composition of polluted air 18a may be known to not include significant amounts of insoluble components. As another example, it may be determined that there is no need to remove the insoluble components by air purification system 10 (e.g., where other purification or containment measures are present).

Catalyzed polluted air 18b (or polluted air 18a , where photo-catalytic processing unit 14 is not present or is bypassed) is directed into scrubber 16. In scrubber 16, catalyzed polluted air 18b is exposed to scrubber liquid 26a. For example, one or more scrubber supply pumps 46 (or other active or passive structure, devices, or features to cause flow of scrubber liquid 26a) may pump scrubber liquid 26a from scrubber liquid supply container 45. The action of scrubber supply pump 46 may cause scrubber liquid 26a to flow via an arrangement of one or more pipes, tubes, or conduits to nozzles 34. Nozzles 34 are configured to produce a suitable spray or stream of scrubber liquid 26a into scrubber 16. Catalyzed polluted air 18b is directed (e.g., through one or more vents, tubes, pipes, conduits, nozzles, or other structure, e.g., facilitated by operation of blower 13) through the spray of scrubber liquid 26a. The spray may be configured to facilitate contact between catalyzed polluted air 18b and scrubber liquid 26a.

For example, scrubber liquid 26a may include water. Alternatively or in addition, scrubber liquid 26a may include one or more other solvents or components that are capable of dissolving, adsorbing, or otherwise removing pollutant components from catalyzed polluted air 18b. For example, scrubber liquid 26a may dissolve upon exposure to catalyzed polluted air 18b one or more pollutant components. Such components may include, for example, volatile organic compounds or substances. Other pollutant components that may be removed from catalyzed polluted air 18b by scrubber liquid 26a may include various inorganic compounds or substances such nitrogen oxides (NOₓ), sulfur oxides (SOₓ), ammonia, or other compounds. Pollutant components that may be removed from catalyzed polluted air 18b by scrubber liquid 26a may include dust or other particulate matter.

Thus, passage through scrubber 16 may purify catalyzed polluted air 18b to form purified air 18c. Purified air 18c may be directed into biological treatment unit 20. For example, scrubber 16 may be open to biological treatment unit 20, e.g., when both are enclosed within a common housing. Alternatively or in addition, one or more vents, ducts, conduits, pipes, tubes, or other structure may enable or direct a flow of purified air 18c from scrubber 16 to biological treatment unit 20.

After exposure of scrubber liquid 26a to catalyzed polluted air 18b, exposed scrubber liquid 26b is collected in scrubber liquid collection container 22. For example, exposed scrubber liquid 26b may fall or drop into scrubber liquid collection container 22 due to the effects of gravity. Scrubber 16 may be configured to facilitate collection of exposed scrubber liquid 26b into scrubber liquid collection container 22. For example, scrubber 16 may be provided with sloped internal surfaces, an internal fan or blower, or other structure or features to facilitate collection of exposed scrubber liquid 26b in scrubber liquid collection container 22.

The collected exposed scrubber liquid 26b may then undergo one or more purification processes. After, purification, the exposed scrubber liquid 26b may be recycled as scrubber liquid 26a for reuse in scrubber 16.

Alternatively or in addition, exposed scrubber liquid 26b may be directed directly to a purification process without being collected in a collection container. For example, exposed scrubber liquid 26b may be caused to drip or flow directly to a treatment unit.

Exposed scrubber liquid 26b may be caused to flow through biological treatment unit 20. For example, one or more pumps 50 (or other active or passive structure, devices, or features to cause flow of exposed scrubber liquid 26b) may cause exposed scrubber liquid 26b to flow via an arrangement of one or more pipes, tubes, or conduits from scrubber liquid collection container 22 to treatment nozzles 42 of biological treatment unit 20. Treatment nozzles 42 are configured to distribute exposed scrubber liquid 26b in the form of a spray, mist, stream, or otherwise, on one or more surfaces of one or more biological treatment substrates 40. For example, treatment nozzles 42 may be configured to distribute exposed scrubber liquid 26b on an upper part of biological treatment substrate 40.

Exposed scrubber liquid 26b that is distributed on a biological treatment substrate 40 may flow across the surface of biological treatment substrate 40. For example, the flow may be caused by gravity, capillary action, or otherwise. During the course of the flow, exposed scrubber liquid 26b is subjected to one or more biological purification processes. For example, exposed scrubber liquid 26b may remain in contact with biological treatment substrate 40 for a period of time ranging from about 1 second to about 300 seconds. Other periods of contact may be used. The biological purification processes may remove a variety of organic or inorganic pollutant substances from exposed scrubber liquid 26b. Aerobic or anaerobic biological processes (e.g., conversion of sulfuric acids to elemental sulfur, or nitric acids to molecular nitrogen, or other biological processes) may remove light metals such as phosphorus, potassium, or other light metals. Biologically treated scrubber liquid 26c may be collected in biological process collection container 44.

Each biological treatment substrate 40 is configured to support a population of microorganisms. As a result of growth of the population of microorganisms on biological treatment substrates 40, surfaces of biological treatment substrates 40 may have a mucous quality. During the biological processing, exposed scrubber liquid 26b may interact with the microorganism population on biological treatment substrate 40.

The population of microorganisms may represent various types of microorganisms. The microorganisms may utilize various pollutant substances in exposed scrubber liquid 26b in various biological processes. For example, the microorganisms may process the pollutant substances to provide nutrients or energy for various digestive or respiratory processes. The microorganisms on biological treatment substrates 40 may include aerobic bacteria, facultative bacteria, or other types of bacteria and microorganisms.

During the biological processing in biological treatment unit 20, various pollutant substances in exposed scrubber liquid 26b may be utilized as nutrients. The nutrients may be utilized by the microorganism population to enable cell growth on biological treatment substrate 40. In some cases, additional nutrients from nutrient supply 58 may be added to biological treatment unit 20 to promote growth or maintenance of the microorganism population on biological treatment substrate 40.

Organic components of exposed scrubber liquid 26b may be utilized as building blocks for growth of the microorganisms. Thus, at least some products of the biological treatment process may be incorporated into cell bodies that adhere to biological treatment substrates 40. Thus, the biological treatment process may increase the mass of cells that adhere to biological treatment substrates 40. In some cases, e.g., in deeper layers of the mass of cells on biological treatment substrates 40, substances may undergo endogenous dissolution with only minimal creation of increased mass.

A respiration process that is associated with the biological activity on biological treatment substrates 40 may include donating electrons to oxygen and release of carbon dioxide and water.

Biological treatment substrates 40 are oriented substantially parallel to a flow of purified air 18c through biological treatment unit 20. The arrangement of biological treatment substrates 40 may facilitate interaction between purified air 18c and exposed scrubber liquid 26b that is distributed on surfaces of biological treatment substrates 40. The flow of purified air 18c across exposed scrubber liquid 26b on biological treatment substrate 40 may enable diffusion exchange of gaseous components between purified air 18c and exposed scrubber liquid 26b. During the gaseous exchange, gaseous components (e.g., oxygen or other components) may diffuse into exposed scrubber liquid 26b from purified air 18c. Other gaseous components (e.g., carbon dioxide or other components) may diffuse out of exposed scrubber liquid 26b into purified air 18c.

The population of microorganisms on biological treatment substrates 40 may enable additional biological treatment processes that act to purify exposed scrubber liquid 26b. Such additional biological treatment processes may include, for example, biological treatment with regard to nitrogen compounds, sulfate compounds, or other biological treatment of polluting components of exposed scrubber liquid 26b.

After passing through biological treatment unit 20, purified air 18c may be directed out of biological treatment unit 20 and air purification system 10. For example, purified air 18c may be directed out an exit vent, conduit, shaft, chimney, or opening of air purification system 10 as vented purified air 18d. Vented purified air 18d may be vented to the ambient atmosphere, or to the interior of a containment structure.

In some cases, purified air 18c may pass through demister unit 56 of air purification system 10 prior to being vented as vented purified air 18d. Demister unit 56 may be configured to remove liquid droplets from purified air 18c prior to venting as vented purified air 18d.

Operation of demister unit 56 may prevent venting of droplets to the ambient atmosphere. Operation of demister unit 56 may increase the efficiency of air purification system 10 by recovering additional scrubber liquid that would otherwise be lost to air purification system 10.

In some cases, exposed scrubber liquid 26b may include metallic components in the form of metals or metallic materials that were removed from catalyzed polluted air 18b by operation of scrubber 16. For example, exposed scrubber liquid 26b may include heavy metal components such as copper, zinc, mercury, or other heavy metals, or light metals such as phosphorus, potassium, or other light metals. In this case, biologically treated scrubber liquid 26c may be caused to flow (e.g., by one or more pumps, not shown) from biological process collection container 44 into physicochemical processing unit 24. Various physical and chemical processes that occur within physicochemical processing unit 24 may remove (e.g., heavy or light) metallic components from biologically treated scrubber liquid 26c. The resulting physicochemically processed scrubber liquid 26d may flow into, or be directed to, scrubber liquid supply container 45.

Alternatively or in addition, exposed scrubber liquid 26b may be directed to physicochemical processing unit 24 prior to treatment in biological treatment unit 20. In this case, physicochemically processed scrubber liquid 26d may then be directed for treatment by biological treatment unit 20. Biologically treated scrubber liquid 26c may then flow directly into scrubber liquid supply container 45.

When no components of exposed scrubber liquid 26b or of biologically treated scrubber liquid 26c require processing by physicochemical processing unit 24 (e.g., where polluting process 12 does not produce heavy metallic pollutant components), biologically treated scrubber liquid 26c may be caused to flow directly into scrubber liquid supply container 45.

Processing in physicochemical processing unit 24 may include exposure to or mixing with one or more chemical substances from chemical processing material supply container 52. The chemical substances may facilitate precipitation of metallic pollutant components or other precipitable pollutant components out of biologically treated scrubber liquid 26c (or exposed scrubber liquid 26b). For example, the chemical substances may promote one or more of coagulation or flocculation of dissolved metallic pollutant components. Precipitants may be caused to settle out of physicochemically processed scrubber liquid 26d by gravity. One or more physical techniques may be applied to facilitate precipitation of precipitants out of physicochemically processed scrubber liquid 26d. Physical techniques may include application of electric or magnetic fields, centrifugal forces, or other suitable techniques.

Precipitants that are removed from physicochemically processed scrubber liquid 26d may form sludge 54. Sludge 54 may include metallic pollutant components and other components that are removed from physicochemically processed scrubber liquid 26d by operation of physicochemical processing unit 24. Sludge 54 may be removed from physicochemical processing unit 24 either continuously, periodically, or as needed. Sludge 54 may be stabilized by one or more processes to enable safe handling and treatment. In some cases, processing in physicochemical processing unit 24 may produce a sludge 54 that is stabilized.

Physicochemically processed scrubber liquid 26d that is contained in scrubber liquid supply container 45 may be utilized as scrubber liquid 26a for treatment of catalyzed polluted air 18b in scrubber 16.

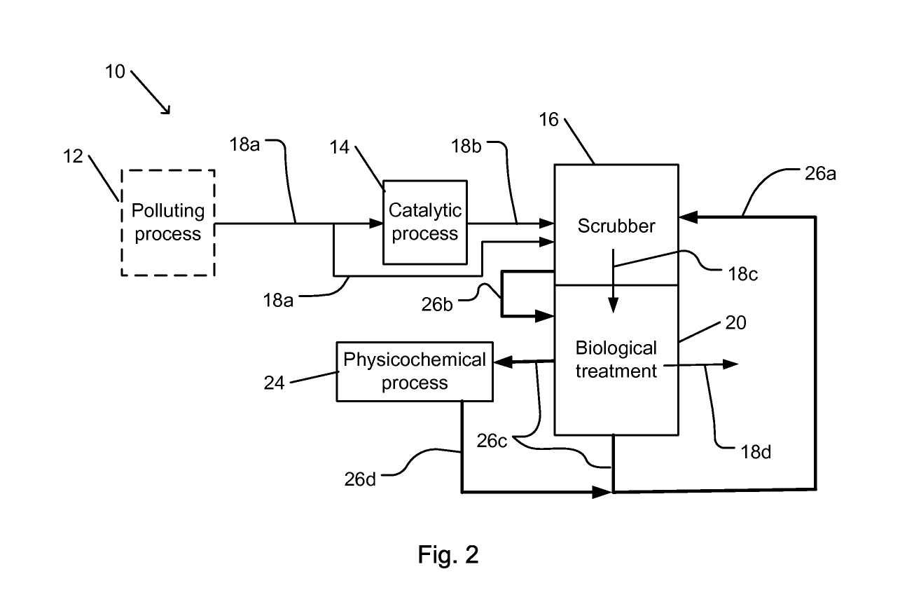

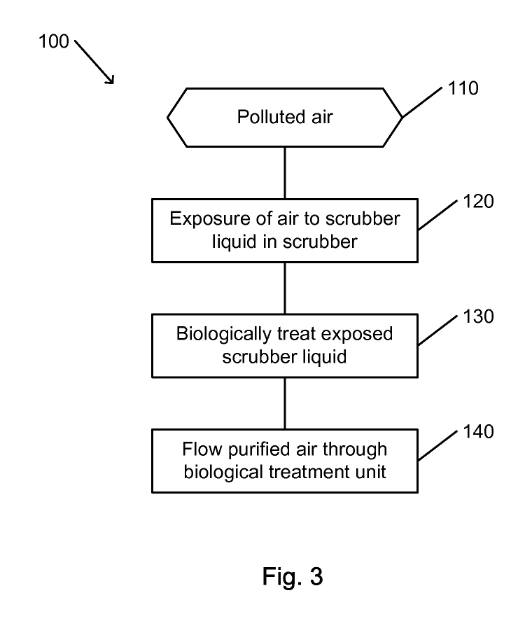

FIG. 2 is a block diagram illustrating a method of air purification, in accordance with an embodiment of the present invention. FIG. 3 is a flowchart depicting a method of air purification, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Air purification method 100 may be performed by air purification system 10 air purification system 10 during continuous or intermittent operation. For example, air purification system 10 may be operated to perform air purification method 100 when a polluting process 12 (such as an industrial process) is emitting polluted air 18a (block 110).

Polluted air 18a may be exposed to scrubber liquid 26a in scrubber 16 (block 120). For example, polluted air 18a may be directed to flow through a spray, mist, stream, or other flow of scrubber 26a. As a result of the exposure, pollutant components of polluted air 18a may be removed by scrubber liquid 26a. Thus, polluted air 18a is converted to purified air 18c, in which at least part of the pollutant components of polluted air 18a are no longer present. Scrubber liquid 26a dissolves, traps, or otherwise captures the removed pollutant components to be collected as exposed scrubber liquid 26b.

In some cases, polluted air 18a may be directed to photo-catalytic processing unit 14 instead of to scrubber 16. Polluted air 18a may be processed in photo-catalytic processing unit 14 to produce catalyzed polluted air 18b. For example, in photo-catalytic processing unit 14, polluted air 18a may be mixed with or otherwise exposed to free radicals. The free radicals may be produced by irradiating one or more components (e.g., a mixture of water and hydrogen peroxide) to ultraviolet radiation. Polluted air 18a may initially include one or more pollutant components that are insoluble in scrubber liquid 26a. As a result of processing in photo-catalytic processing unit 14, those pollutant components may be converted to materials that are soluble in scrubber liquid 26a. Catalyzed polluted air 18b, that includes the soluble materials, may be exposed to scrubber liquid 18a in scrubber 16, where it is converted to purified air 18c.

Exposed scrubber liquid 26b, which was collected from scrubber 16, may be directed to biological treatment unit 20 for biological treatment (block 130). Within biological treatment unit 20, organic or inorganic pollutant components of exposed scrubber liquid 26b may be removed by one or more biological processes. The biological processes may occur as the result of contact of exposed scrubber liquid 26b with a population of microorganisms on a biological treatment substrate within biological treatment unit 20. For example, the microorganism population may remove the pollutant components as part of a metabolic or reproductive biological or biochemical process. The resulting biologically treated scrubber liquid 26c may be collected for further purification or for recycling or reuse.

In some cases, biologically treated scrubber liquid 26c may be caused to flow to scrubber 16 for recycling or reuse as scrubber liquid 26a. For example, biologically treated scrubber liquid 26c may be reused directly as scrubber liquid 26a when exposed scrubber liquid 26b or biologically treated scrubber liquid 26c do not require further physicochemical treatment. Biologically treated scrubber liquid 26c may be reused directly if exposed scrubber liquid 26b was processed in physicochemical processing unit 24 prior to treatment in biological treatment unit 20.

In some cases, exposed scrubber liquid 26b or biologically treated scrubber liquid 26c may include metallic components, or other components that may be removed by a physicochemical process. Exposed scrubber liquid 26b or biologically treated scrubber liquid 26c may be then be processed by physicochemical processing unit 24. Processing by physicochemical processing unit 24 may cause one or more pollutant components (e.g., metallic components) of exposed scrubber liquid 26b or of biologically treated scrubber liquid 26c to precipitate and form a stabilized sludge. Processing in physicochemical processing unit 24 may take place before, after, or concurrently with treatment in biological treatment unit 20. The resulting physicochemically processed scrubber liquid 26d may be recycled. Physicochemically processed scrubber liquid 26d caused to flow to scrubber 16 for reuse as scrubber liquid 26a. In a case where physicochemically processed scrubber liquid 26d has not yet been biologically treated, physicochemically processed scrubber liquid 26d may be directed to biological treatment unit 20 for biological treatment.

Purified air 18c from scrubber 16 may also be caused to flow through biological treatment unit 20 (block 140). Purified air 18c may flow across a surface of a biological treatment substrate in biological treatment unit 20, between two biological treatment substrates, or both. The flow of purified air 18c across a surface of the biological treatment substrates is substantially parallel to the surface. The flow of purified air 18c through biological treatment unit 20 may facilitate the biological process. For example, the flow of purified air 18c through biological treatment unit 20 may facilitate exchange of gasses between purified air 18c and exposed scrubber liquid 26b. For example, the exchanged gasses may be required by one or more microorganism populations for a biological process by, or may be produced as a product or byproduct of the biological process.

After flowing through biological treatment unit 20, purified air 18c may be vented from air purification system 10 as vented purified air 18d. Vented purified air 18d may be vented to ambient surroundings. For example, the ambient surroundings may include the surrounding atmosphere or the interior of a containment structure. Purified air 18c may be demisted in a demister prior to venting as vented purified air 18d.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An air purification system for purifying polluted air, the system comprising:
a scrubber in which a pollutant in the polluted air is transferred to a scrubber liquid; and
a biological treatment unit comprising at least one substantially flat substrate to support a microorganism population to remove the transferred pollutant from the scrubber liquid when the scrubber liquid with the transferred pollutant is distributed on said at least one substrate, a plane of said at least one substrate being substantially parallel to a direction of flow of the air from the scrubber.

2. The system of claim 1, further comprising a photo-catalytic processor in which the polluted air is exposed to a catalyst to facilitate conversion of a pollutant component of the polluted air that is insoluble in the scrubber liquid to a substance that is soluble in the scrubber liquid.

3. The system of claim 2, wherein the catalyst is formed by irradiating a material with ultraviolet radiation.

4. The system of claim 3, wherein the material includes a mixture of hydrogen peroxide and water.

5. The system of claim 1, comprising a blower to cause the air to flow.

6. The system of claim 1, comprising a pump to cause the scrubber fluid to flow.

7. The system of claim 1, comprising a demister to remove droplets from the air.

8. The system of claim 1, comprising one or a plurality of nozzles to distribute the scrubber liquid onto the substrate.

9. The system of claim 1, comprising a physicochemical processor to facilitate precipitation of a precipitable pollutant out of the scrubber liquid.

10. The system of claim 9, wherein the physicochemical processor is configured to mix the scrubber liquid with a chemical substance to facilitate the precipitation.

11. The system of claim 1, wherein the system is configured to recycle the scrubber liquid for use in the scrubber after treatment of the scrubber liquid in the biological treatment unit.

12. An air purification method for purifying polluted air, the method comprising:
exposing a scrubber liquid to the polluted air in a scrubber to enable a pollutant in the polluted air to transfer to the scrubber liquid;
distributing the scrubber liquid with the transferred pollutant on a substantially flat substrate of a biological treatment unit to enable a microorganism population that is supported by the substrate to remove the pollutant from the scrubber liquid; and
causing air from the scrubber to flow across a surface of the substrate in a direction that is substantially parallel to the surface.

13. The method of claim 12, further comprising exposing the polluted air to a catalyst that is produced by irradiating a material with ultraviolet radiation.

14. The method of claim 12, wherein the material comprises a mixture of hydrogen peroxide and water.

15. The method of claim 12, further comprising demisting the air.

16. The method of claim 12, further comprising processing the scrubber liquid with a physicochemical process to facilitate precipitation of a precipitable pollutant out of the scrubber liquid.

17. The method of claim 16, wherein the physicochemical process comprises mixing the scrubber liquid with a chemical substance.

18. The method of claim 16, wherein the precipitable pollutant comprises a metal.

19. The method of claim 12, further comprising recycling the scrubber liquid to the scrubber after removal of the pollutant by the microorganism population.

20. A biological treatment unit for an air purification system, the unit comprising at least one substantially flat substrate to support a microorganism population onto which a scrubber liquid may be distributed after a pollutant is transferred from polluted air to the scrubber liquid in a scrubber, the microorganism population to remove the pollutant from a scrubber liquid, a plane of the substrate being substantially parallel to a direction of flow of the air from the scrubber.
